(19) United States
(12) Patent Application Publication
(10) Pub. No.: US 2009/0101179 A1
(43) Pub. Date: Apr. 23, 2009

(54) Robot system and method for molybdenum roasting furnaces cleaning procedures

(76) Inventor: Hugo Salamanca, Santiago (CL)

Correspondence Address: GOTTLIEB RACKMAN & REISMAN PC, 270 MADISON AVENUE, 8TH FLOOR, NEW YORK, NY, 10016-0601, US

(21) Appl. No.: 11/595,951

(22) Filed: Nov. 13, 2006

Related U.S. Application Data
(60) Provisional application No. 60/734,970, filed on Nov. 10, 2005.

(51) Int. Cl. B08B 9/027

(52) U.S. Cl. 134/24; 134/172

(57) ABSTRACT

At present, the cleaning procedures for roasting furnaces are carried out manually. Due to the demanding operating conditions for the plant personnel, there is a decrease in the furnace performance which means less productivity. Due to the above, a robot system and method have been developed for the cleaning of molybdenum roasting furnaces.

The robotic system is composed mainly of an anthropomorphous robotic manipulator (1) of at least 5 degrees of freedom which is mounted on each floor of the furnace (2) and provided with a gripping mechanism (3) which allows to take a rugged device in a spraying or rotary brush system (4) which is lifted and moved to the window of the furnace to be used in the cleaning process for the roasting furnace through the localized cleaning in arms, harrows, passes, inner walls, plate and shaft of the roasting furnace. Once this is done, the gripping mechanism (3) withdraws and removes the tool system from the furnace window. (5)

### CROSS-REFERENCE TO RELATED APPLICATIONS

This application claims the benefit of provisional patent application Ser. No. 60/734,970 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry, specifically repetitive and dangerous activities in the molybdenum roasting furnace.

2. Prior Art

During the copper concentration process, the molybdenum concentrate byproduct (molybdenum disulfide MoS2) is obtained which is characterized by a darkish and very slippery fine dust. This material is subjected to a process called roasting to eliminate the sulphur, so as the molybdenum concentrates are roasted in level furnaces at temperatures over 650° C. to produce technical molybdenum oxide with a fine molybdenum content of about 57%.

The resulting product being commercialized is the molybdenum trioxide of technical grade, which is a greenish yellow dust that is sold packed in drums, small drums or in briquettes in maxi bags.

During the operation of the roasting furnace the levels are cleaned on a regular basis, which is intended to eliminate the accretions built up and adhered to the different parts of the furnace due to material cooling and/or a change in the chemical composition, making the operation of the furnace difficult. The cleaning process is carried out by the operators of the shift and each operator cleans 4 levels.

The cleaning activities currently being performed are based on removal through mechanical tools by using the tools described above. Some problems are present such as:
Harsh environmental conditions and the handling of large tools which present a high demand to operators. These factors causes the plant operators to not carry out these activities thoroughly and, consequently, the efficiency of the cleaning is low.
Safety: the operators must perform cleaning activities with the harrows in movement which generates a risk of trapping the tools with the possibility of causing damage to the people and the equipment (harrow break).
There are geometry problems which hinder the operators to properly cover all the areas that require cleaning.

The above situations make the cleaning a not effective process, by decreasing the performance of the furnace, the average time for faults, shortening the maintenance intervals. At present, the furnace must be stopped for a complete cleaning due to the fact there is a loss in efficiency resulting from the fact the cleaning activities are not effective.

### SUMMARY

A robot system and method have been developed for an automated cleaning of molybdenum rotating furnaces. The robotic manipulator takes different tools to clean each section of the furnace level that it has been assigned.

### DRAWINGS

### Figures

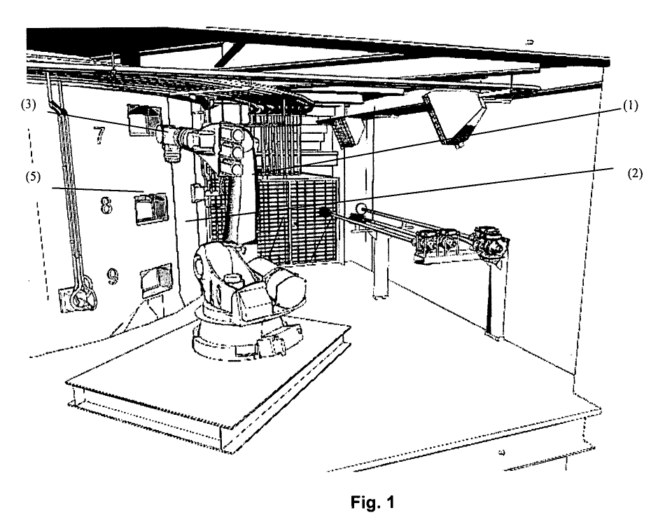

FIG. 1. View of the robotic manipulator introducing the spraying nozzle through the roasting furnace window.

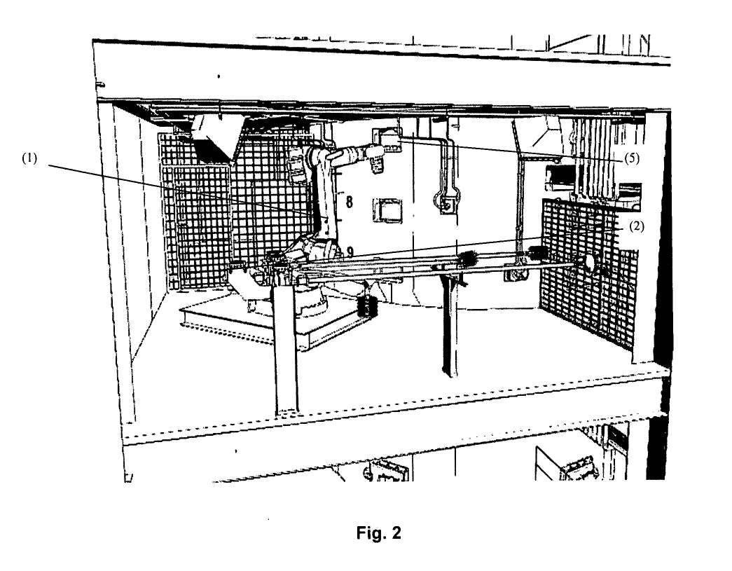

FIG. 2. General view of a robot system for cleaning the roasting furnace.

### DRAWINGS

### Reference Numerals

1. Robotic manipulator
2. Roasting furnace
3. Gripping mechanism
4. Tool
5. Window of the furnace

### DETAILED DESCRIPTION

This invention relates to a new robot system as well as a robotic method for cleaning the molybdenum roasting furnaces, which are mainly composed of an anthropomorphous robotic arm of at least 5 degrees of freedom, which is provided with a gripping mechanism to take a device composed of a spraying system being introduced through the window of the furnace to be used to clean the arms, harrows, passes, inner walls, plate and shaft through the focalized injection of, or through the mechanical action of rotary brushes.

With reference to FIG. 1 and FIG. 2, the system is composed mainly of one anthropomorphous robotic manipulator (1) of at least 5 degrees of freedom, provided with a communication, acquisition and control system, which is mounted at one side of each level of the roasting furnace (2) and which is provided with a gripping mechanism (3) which allows to take a spraying or rotary brush system (4) which is lifted and moved to the window of the furnace to be used in the localized cleaning of arms, harrows, passes, inner walls, plate and shaft of the roasting furnace. Once this process is carried out, the gripping mechanism (3) withdraws and removes the spraying system to the window of the furnace. (5)

I claim:

1. A robot system for cleaning the molybdenum roasting furnaces, comprising an anthropomorphous robotic arm of at least 5 degrees of freedom, one control, communication and programming unit, one gripper adapter, one pneumatic gripper, its fingers, one pneumatic gripper driving system, one electric supply system, one spraying and/or rotary brushes system and one fixed tool holder wherein the anthropomorphous robotic arm of at least 5 degrees of freedom is provided with a pneumatic gripping mechanism which allows in a sequential and programmed way to take, manipulate and release from a fixed tool holder located at one of the sides of the robot a cleaning device or apparatus which is composed of a spraying and/or rotary brush system which is lifted and moved to the window of the furnace to be used in the cleaning of the roasting furnace through the localized cleaning in arms, harrows, passes, inner wall, plate and shaft of the roasting furnace.

2. A robot system for cleaning the molybdenum roasting furnaces according to claim 1, wherein the anthropomorphous robotic manipulator could communicate by itself or through a PLC interface with the control system.

3. A robot system for cleaning the molybdenum roasting furnaces according to claim 1, wherein the anthropomorphous robotic manipulator has the capacity to obtain and interpret the information from installed analogue and/or digital sensors.

4. A robot system for cleaning the molybdenum roasting furnaces according to claim 1, wherein the anthropomorphous robotic manipulator has the capacity to generate analogue and/or digital signals to control analogue and/or digital input devices.

5. A robot system for cleaning the molybdenum roasting furnaces according to claim 1, wherein the robotic manipulator has a pneumatic gripping mechanism which allows to take, manipulate and release in a sequential and programmed way the tools used for cleaning the harrows, passes, inner wall, plate and roasting furnace.

6. A robot system for cleaning the molybdenum roasting furnaces according to claim 1, wherein the anthropomorphous robotic manipulator has an electrical system driven by three-stage induction motors, with vectorial and/or scalar control.

7. A robot system for cleaning the molybdenum roasting furnaces according to claim 1, wherein its has the capacity to move and manipulate the tools in different paths within the work volume of the robotic system.

8. A robot system for cleaning the molybdenum roasting furnaces according to claim 1, wherein it uses a fixed tool holder from which the robotic manipulator withdraws the spraying and/or rotary brush system which is used in the cleaning process of the furnace.

9. A robot system for cleaning the molybdenum roasting furnaces according to claim 1, wherein productivity and efficiency in the roasting process of molybdenite increases.

10. A robot system for cleaning of roasting furnaces according to claim 1, wherein it could be integrated to the cleaning process of any level furnace in metallurgical and/or chemical processes.

11. A robot system for cleaning roasting furnaces according to claim 1, wherein the system prevents the plant personnel from being subjected to a high physical demand and harsh environmental conditions.

12. A robot system for cleaning the roasting furnaces according to claim 1, wherein the system may operate automatically, or semi-automatically, and also allows solutions scalability.

13. A robotic method for roasting furnace cleaning processes using the robot System of claim 1 to 12, wherein the anthropomorphous robotic arm of at least 5 degrees of freedom is provided with a pneumatic gripping mechanism which allows in a sequential and programmed way to take, manipulate and release from a fixed tool holder located at one side of the robot, a cleaning device or apparatus which is composed of a spraying and/or rotary brush system which is lifted and moved to the window of the furnace to be used in the cleaning process of roasting furnace through the localized cleaning of arms, harrows, passes, inner wall, plate and shaft of the roasting furnace.

14. A robotic method for roasting furnaces cleaning processes using the robot System of claim 1 to 12, wherein the anthropomorphous robotic manipulator could communicate by itself or through a PLC interface with the control system.

15. A robotic method for roasting furnace cleaning processes using the robot System of claim 1 to 12 wherein the anthropomorphous robotic manipulator has the capacity to obtain and interpret the information from installed analogue and/or digital sensors.

16. A robotic method for roasting furnace cleaning processes using the robot System of claim 1 to 12, wherein the anthropomorphous robotic manipulator has the capacity to generate analogue and/or digital signals to control the analogue and/or digital inputs devices.

17. A robotic method for roasting furnace cleaning processes using the robot System of claim 1 to 12, wherein the robotic manipulator has a pneumatic gripping mechanism which allows, in a sequential and programmed way, to take, manipulate and release the tools to be used in the cleaning process of arms, passes, inner wall, plate and shaft of the roasting furnace.

18. A robotic method for roasting furnace cleaning processes using the robot System of claim 1 to 12, wherein the anthropomorphous robotic manipulator has an electrical system driven by three-stage induction motors with vectorial and/or scalar control

19. A robotic method for roasting furnace cleaning processes using the robot System of claim 1 to 12, wherein the system has the capacity to move and manipulate the tools in different paths within the work volume of the robotic system.

20. A robotic method for roasting furnace cleaning processes using the robot System of claim 1 to 12, wherein it uses a fixed tool holder from which the robotic manipulator withdraws the spraying and/or rotary brush system which is used in the cleaning process of the furnace.

21. A robotic method for roasting furnace cleaning processes using the robot System of claim 1 to 12, wherein productivity and efficiency of the molybdenite roasting process increases.

22. A robotic method for roasting furnace cleaning processes using the robot System of claim 1 to 12, wherein it could be integrated to the cleaning process of any level furnace used in metallurgical and/or chemical processes.

23. A robotic method for roasting furnace cleaning processes using the robot System of claim 1 to 12, wherein the system prevents the plant personnel from being subjected to a high physical demand and harsh environmental conditions.

24. A robotic method for roasting furnace cleaning processes using the robot System of claim 1 to 12, wherein the system may operate automatically or semi-automatically, and also allows solution scalability.

25. Tools for roasting furnace cleaning processes using the robot System of claim 1 to 12 wherein they are used in the cleaning process localized in arms, harrows, passes, inner wall, plate and shaft of the roasting furnace.

26. Cleaning tool and/or device for roasting furnace cleaning processes using the robot System of claim 1 to 12 wherein it is comprised of a spraying or rotary brush system which is lifted and moved to the window of the furnace to be used in the cleaning process of the roasting furnace through the localized cleaning in arms, harrows, passes, inner wall, plate and shaft of the roasting furnace, so that once the cleaning process has ended the gripping mechanism withdraws and removes the spraying system from the window of the furnace.
